(19) United States
(12) Patent Application Publication
(10) Pub. No.: US 2009/0254960 A1
(43) Pub. Date: Oct. 8, 2009

(54) METHOD FOR A CLUSTERED CENTRALIZED STREAMING SYSTEM

(75) Inventors: Eran Yarom, Even Yehuda (IL); Eran Bida, Holon (IL); Lior Mualem, Holon (IL)

Correspondence Address: BROWDY AND NEIMARK, P.L.L.C.;624 NINTH STREET, NW, SUITE 300, WASHINGTON, DC, 20001-5303, US

(73) Assignee: VIDEOCELLS LTD., Petach Tikva (IL)

(21) Appl. No.: 11/908,910

(22) PCT Filed: Mar. 16, 2006
(86) PCT No.: PCT/IL2006/000349

§ 371 Date: Sep. 17, 2007

Related U.S. Application Data
(60) Provisional application No. 60/662,373, filed on Mar. 17, 2005.

(51) Int. Cl. H04N 7/173; G06F 15/16

(52) U.S. Cl. 725/115; 725/116; 709/225

(57) ABSTRACT

Methods and systems for providing centralized video accounts where videos are received over a communication network from video sources associated with a plurality of accounts and the videos or processed versions thereof are transmitted over a communication network to corresponding users of the plurality of accounts. In another aspect of the invention a new communication protocol for network components is disclosed.

### FIELD OF THE INVENTION

The invention relates to the field of video.

### BACKGROUND OF THE INVENTION

A digital video recorder (DVR) is a device which offers video controlling abilities for digital video from video source(s). Similarly to a commonplace analog VCR, the DVR enables storing, replaying, rewinding and fast forwarding, but in addition it also typically includes advanced features such as time marking, indexing, and non-linear editing due to the extended capabilities of the digital format.

The DVR typically needs to be installed in proximity to the video source(s), for example where the coaxial cable from the video sources terminate. For this reason, among others, the site where the video sources are installed typically requires an investment in infrastructure to accommodate the DVR, as well as an investment in expert maintenance and security. Moreover, because each DVR is typically limited in the number of video sources which can be inputted into a single DVR, the investment can not be recouped through economies of scale.

### SUMMARY OF THE INVENTION

According to the present invention, there is provided: a system for providing users with video services over a communication network comprising: a clustered centralized streaming system configured to receive over a communication network videos from video sources associated with a plurality of accounts and configured to transmit over a communication network the received videos or processed versions thereof to corresponding users of the plurality of accounts.

According to the present invention there is also provided: a method of providing users with video services over a communication network comprising: upon occurrence of an event, receiving a video stream from a video source associated with an account via a communication network; and performing an action relating to the video stream in accordance with the account.

According to the present invention, there is further provided: a method of providing users with video services over a communication network comprising: receiving from a user a request for video; determining an account associated with the request; determining a video source valid for the account and the request; and providing video from the determined video source or a processed version thereof to the user.

According to the present invention, there is yet further provided: a protocol for communicating between a system and a network component, comprising: a network component sending a registration request, including a component identification; and the system returning a registration reply indicating success or failure for the registration request.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic illustration of different configurations of a system according to an embodiment of the present invention;

FIG. 2 is a schematic illustration of a clustered centralized streaming system, according to an embodiment of the present invention;

FIG. 3 is a flowchart of a method for receiving video from a video source associated with an account, according to an embodiment of the present invention;

FIG. 4 is a flowchart of a method for accessing video associated with an account, according to an embodiment of the present invention;

FIG. 5 is a graphical user interface on a destination device, according to an embodiment of the present invention;

FIG. 6 is another graphical user interface on a destination device, according to an embodiment of the present invention;

FIG. 7 is another graphical user interface on a destination device, according to an embodiment of the present invention;

FIG. 8 is another graphical user interface on a destination device, according to an embodiment of the present invention;

FIG. 9 is another graphical user interface on a destination device, according to an embodiment of the present invention;

FIG. 10 is another graphical user interface on a destination device, according to an embodiment of the present invention; and

FIG. 11 is another graphical user interface on a destination device, according to an embodiment of the present invention.

### DETAILED DESCRIPTION OF EXEMPLARY EMBODIMENTS

One embodiment of the current invention relates to the provision of video from video sources associated with a plurality of centralized accounts to corresponding users via communication networks.

As used herein, the phrase “for example,” “such as” and variants thereof describing exemplary implementations of the present invention are exemplary in nature and not limiting.

One embodiment of the present invention provides a full solution carrier class platform intended for the simultaneous management of more than one video account, using a centralized system. In this embodiment, the video is distributed via a communication network. Although the singular form for communication network is used herein below, the reader should understand that in some embodiments there may be a combination of communication networks (as defined below) used for distribution. Herein below, the terms “clustered centralized streaming system” or “CCSS” are used for a system which receives and distributes video over a communication network.

The term entity in the description herein refers to a company, organization, partnership, individual, group of individuals, government, or any other grouping.

In the description herein, the term CCSS operator refers to an entity which owns and/or manages one or more CCSS described herein.

In the description herein, the term user refers to an entity which has an account with the CCSS operator and/or to an entity which otherwise has access to an account with the CCSS operator. For example a user can include inter-alia: individual, family, small business, medium sized business, large business, organization, government (local, state, federal), or any other entity.

Embodiments of the invention are described below with reference to video, however it should be understood that in some cases the video is accompanied by audio and/or data which may or may not use the same protocol and stream as the video, and that these cases are also included in the scope of the invention.

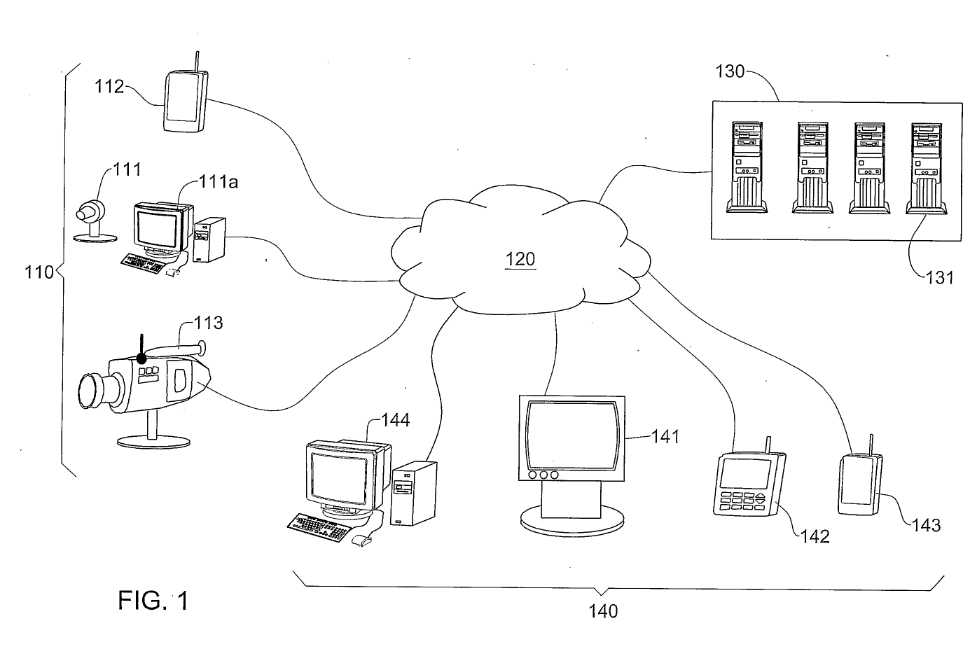

Referring now to the drawings, FIG. 1 is a schematic illustration of different configurations of a system according to an embodiment of the present invention. In other embodiments, there may be different configurations, more elements, less elements or different elements than those shown in FIG. 1. Each of the elements shown in FIG. 1 may be made up of any combination of software, hardware and/or firmware that performs the functions as defined and explained herein. A plurality of video input sources 110 are connected via a communication network 120 to an CCSS 130 of the invention. In one embodiment, video input sources 110 may include inter-alia: IP cameras, webcams, 3G cell-phone cameras, video feed, analog video camera, AVDIO (audio, video, data, input/output) component, and/or any other device configured to take video. For the sake of example in FIG. 1 are illustrated some of the possible video sources 110: an IP camera 113 which is directly connected to the internet and is identified via a designated internet protocol (IP) address, a web camera (webcam) 111 which is connected to the internet through a client station 111a, and a camera of a 3G cellular phone 112.

In one embodiment, all video sources 110 are digital so there is no need for analog to digital conversion of the video outputted by sources 110. In another embodiment, one or more video sources 110 may be analog and analog to digital conversion may take place, for example prior to transferring the video over network 120. For example analog video sources may be connected to a device (such as Mango-DSP) that converts the analog video to IP video streams. The analog video inputs can be connected to the Mango-DSP using BNC cable, and any analog audio inputs are connected using RCA cable. Analog to digital conversion is known in the art and will therefore not be further discussed.

In one embodiment, there is no need for coaxial cables connecting video sources 110, and video sources 110 are connected directly or indirectly to network 120.

In one embodiment there is no geographical limitation on where the video sources 110 are located, and even a plurality of video sources 110 associated with the same account may be spread out over a large geographical area, if so desired.

For ease of explanation, the term “video source” is sometimes used in the description below, as appropriate, to connote the combination of the video taking means and any means which allows the video taking means to be connected to network 120 and/or allows the video to be streamed via network 120. In other cases, the term “video source” is used in the description below to connote the video taking means, as appropriate. The appropriate connotation will be understood by the reader.

In one embodiment, video streams are sent from video sources 110 using the standardized packet form for delivering video over the Internet defined by the real time transport protocol RTP (for example RFC 1889). In one embodiment the video streams are controlled by CCSS 130 using the real time streaming protocol RTSP (for example RFC 2326) which allows for example CCSS 130 to remotely control sources 110.

In some embodiments, in order for CCSS 130 to communicate with video sources 110, for example in order to configure and control video sources 110 and the streaming of video from video sources 110 and/or for example in order to correctly receive the video streams from video sources 110, CCSS 130 requires one or more different adapters. For example, in one of these embodiments, CCSS 130 may have a substantial number of different adapters, each allowing CCSS to communicate with a different type of video sources 110 (where here the same type of video sources refers to video sources for which the same adapter can be used.) As another example, in another of these embodiments, the number of different adapters required by CCSS 130 may be substantially reduced through the adoption by some or all of the currently different types of video sources 110 of a uniform protocol for communicating with CCSS 130 (thereby transforming the currently different types after adoption of the uniform protocol to the “same” type from the adapter perspective, and allowing the usage of the same type of adapter for all sources 110 that have adopted the uniform protocol). Herein below the uniform protocol is sometimes called VideoCells Network Component Protocol VCNCP.

For example, the uniform protocol VCNCP used by video sources 110 may comprise the following steps: video source 110 when first connecting directly or indirectly to CCSS 130 will send a register message to CCSS 130 which includes information on video source 110 including one or more of the following inter-alia: component name, component manufacturer, component description, and component identification. Video source 110 will then receive a registration reply from CCSS 130 including inter-alia one or more of the following: registration success, registration failure (already registered), or registration failure (registration not allowed). Thereafter, each time video source 110 wishes to connect to CCSS 130, video source 110 sends a login request message. More details on one embodiment of VCNCP are provided further below. Optionally, at some point in the video source registration process, the user may be prompted for an existing account number managed by CCSS 130 and password or may be asked to provide user information so that a new account can be established for the user. The registered video source 110 will be associated with the account.

If the uniform protocol is not used then CCSS 130 at the initial registration using any conventional registration procedure determines the parameters of the particular video source 110 including one or more of the following inter-alia: the specific type of the device (selected from a known list), and the IP address (for example if video source 110 is a static IP camera) or a URL (for example if video source 110 is using a domain name server DNS).

CCSS 130 is also connected to a plurality of client destination devices 140 with video displaying capabilities, via communication network 120. Client destination device 140 may include any type of device which can connect to a network and display video data, including inter-alia: as personal computers, television sets (including or excluding cableboxes), network personal digital assistants (PDA), multi-media phones such as second generation (2G, 2.5G) or third generation (3G) mobile phones and/or any other suitable device. In one embodiment, destination client 140 may communicate with CCSS 130 via conventional means, for example using a web browser or wireless application protocol WAP, without requiring a dedicated module or customized application. In another embodiment, in addition or instead, the destination client may include a dedicated module for communicating with CCSS 130. In another embodiment, in addition or instead, the destination client may include a customized application for communicating with CCSS 130.

For the sake of example illustrated in FIG. 1 are some of the possible client destination devices 140: a desktop computer 144, a television set 141, a network PDA 142 and a GPRS-3G mobile phone 143. In one embodiment, client destination devices 110 are not limited in geographical location.

In one embodiment, video streams are sent from CCSS 130 to destination devices 140 using RTP. In one embodiment the video streams from CCSS 130 are controlled by destination devices 140 using RTSP which allows for example destination device 140 to remotely control CCSS 130, by issuing commands such as “play” and “pause”, and which allows for example time-based access to files on CCSS 130.

In one embodiment, there is no requirement to register a destination device 140 with CCSS 130, prior to requesting video, and each time there is a request, CCSS 130 determines the relevant parameters of destination device 140 as will be explained further below. In another embodiment, destination device 140 registers with CCSS 130, for example using any conventional method. CCSS 130 at the initial registration using any conventional registration procedure determines the parameters of the particular destination device 110 including one or more of the following inter-alia: the specific type of the device (selected from a known list), and optionally the IP address or a URL.

In one embodiment, in order for CCSS 130 to communicate with destination devices 140, for example in order to configure and control destination devices 140 and/or for example in order to correctly transmit the video streams to destination devices 140, CCSS 130 requires one or more different adapters.

Network communication between the system 130 and sources 110 and between system 130 and destinations devices 140 occurs via communication network 120. Communication network 120 may be any suitable communication network (or in embodiments where communication network 120 includes a combination of networks, communication network 120 may include a plurality of suitable communication networks). The term communication network should be understood to refer to any suitable combination of one or more physical communication means and application protocol(s). Examples of physical means include, inter-alia: cable, optical (fiber), wireless (radio frequency), wireless (microwave), wireless (infra-red), twisted pair, coaxial, telephone wires, underwater acoustic waves, etc. Examples of application protocols include inter-alia Short Messaging Service Protocols, WAP, File Transfer Protocol (FTP), RTSP, RTP, Telnet, Simple Mail Transfer Protocol (SMTP), Hyper Text Transport Protocol (HTTP), Simple Network Management Protocol (SNMP), Network News Transport Protocol (NNTP), Audio (MP3, WAV, AIFF, Analog), Video (MPEG, AVI, Quicktime, RM), Fax (Class 1, Class 2, Class 2.0), and tele/Nideo conferencing. In some embodiments, a communication network can alternatively or in addition may be identified by the middle layers, with examples including inter-alia the data link layer (modem, RS232, Ethernet, PPP point to point protocol, serial line internet protocol-SLIP, etc), network layer (Internet Protocol-IP, User Datagram Protocol-UDP, address resolution protocol-ARP, telephone number, caller ID, etc.), transport layer (TCP, UDP, Smalltalk, etc), session layer (sockets, Secure Sockets Layer-SSL, etc), and/or presentation layer (floating points, bits, integers, HTML, XML, etc).

In one embodiment of the invention, one or more of the following protocols are used by CCSS 130 and sources 110 and/or by CCSS 130 and destination devices 140 when communicating via communication network 120: VCNCP, RTP, RTSP, TCP, UDP, HTTP

CCSS 130 may be made up of any combination of software, hardware and/or firmware that performs the functionalities as defined and explained herein. In one embodiment, CCSS 130 is configured to provide one or more of the following functionalities inter-alia: receiving video from sources 110, communicating with video sources 110, storage of some or all of the video received from sources 110, processing requests from destination devices 140 or elsewhere to receive video, communicating with destination devices 140, processing of video, management of user accounts, and load balancing. In one embodiment, CCSS 130 provides extensive storage and accessibility capabilities, in addition to flexible hardware/software/firmware and communication format compatibilities. As mentioned above, CCSS 130 is associated with an operator. In one embodiment, the operator is a phone company, cellular company, Internet service provider, or security company. In other embodiments, the operator can be any entity.

In some embodiments, CCSS 130 includes features which enhance compatibility with other systems residing at the operator. For example in one of these embodiments, CCSS 130 includes an application program interface API which allows applications to be developed by others to also reside at the operator. For example, the API may allow other systems at the operator to use the uniform protocol discussed above to communicate with CCSS 130. In one of these embodiments, CCSS 130 supports SNMP.

In some embodiments, CCSS 130 comprises a cluster of servers 131. The cluster of servers 131 can be configured in any suitable configuration, and the servers 131 used in the cluster may be any appropriate servers. In one embodiment, CCSS 130 comprises one or more comprehensive servers 131, each containing multiple slots, each slot able to contain and manage data received from many video sources 110 simultaneously (for example up to a 1,000 video sources 110), such as a blade server). In another embodiment, CCSS 130 includes instead or in addition rack-mounted slots in one or more servers 131. In some embodiments, the number of server(s) 131 included in CCSS 130 is expandable and may thus support a potentially unlimited number of users. Thus, CCSS 130 is capable of storing, managing and retrieving mass amounts of video. In one of these embodiments, servers 131 or slots therein may be added to CCSS 130 if necessary even while CCSS 130 is in operation. Servers are known in the art and therefore the composition of servers 131 will not be elaborated on here.

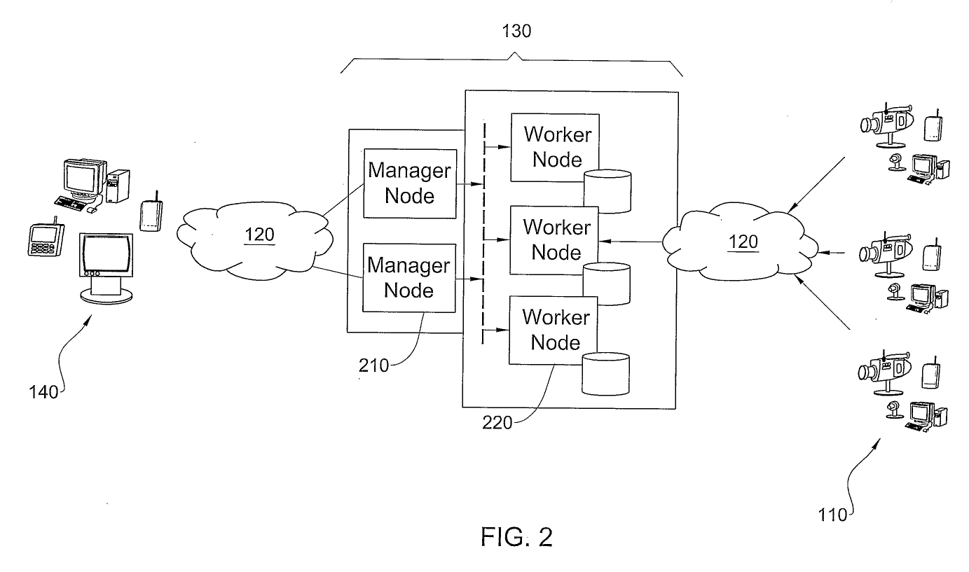

In some embodiments, one of which is illustrated in FIG. 2, the cluster of servers 131 are divided into one or more manager nodes 210 and one or more worker nodes 220. For the sake of example, FIG. 2 illustrates two manager nodes 210 and three worker nodes 220, however it should be evident that the invention is not bound by the number of manager nodes 210 and/or worker nodes 220. Also for the sake of example it is assumed that each node 210 or 220 corresponds to one server 131 however it should be evident that each node 210 or 220 may correspond to a different number or fraction of servers 131. The description below assumes a division of functionality between manager nodes 210 and worker nodes 220, but in an embodiment where there is no division of functionality between manager nodes 210 and worker nodes 220, similar methods and systems can be applied mutatis mutandis.

In one embodiment, manager node(s) 210 oversee the work performed by worker node(s) 220 relating to video streams which pass through CCSS 130, in order to ensure efficient operation and/or conformity with corresponding accounts managed by CCSS 130. In another embodiment, manager node(s) 210 in addition or instead has access to all data needed to establish the communication with sources 110 and/or destination devices 140 such as its IP address, the data and control communication protocols, and/or source/destination and communication characteristics. In another embodiment, management node(s) 210 in addition or instead manage the accounts.

For example in one embodiment, in order to provide more efficient operation, a load balancing service may run on one or more of manager nodes 210. Therefore requests for video from destination devices 140 are first received by manager node 210. Manager node 210 then decides (based on inter-alia load balancing consideration) to which worker node 220 to forward the request. For example, in one embodiment, a request for live video will be forwarded to a worker node 220, which is already handling a request for the same live video, if any. As another example, in one embodiment, a request for stored video will be forwarded to a worker node 220 where the video is stored, or the closest node to the storage. It should be noted that in some embodiments, there is redundant storage of video and/or redundant receipt of live video by worker nodes 220 and in these embodiments, the forwarding will be to one or more of the redundant worker nodes 220.

As another example, in one embodiment in order to provide efficient operation, one or more manager node(s) 210 may be configured to detect any failure by worker node(s) 220. In such a case, manager node(s) 210 can retrieve tasks which had been assigned to the failed node 220, for example during a predetermined period of time prior to the detection, and reassign those tasks to other worker node(s) 220. Any storage, for example of video, on the failed node 220 can also or instead be reassigned by the manager node(s) to other worker node(s) 220.

As another example, in one embodiment one or more manager nodes 210 may have access to a correspondence between accounts and video streams handled by worker node(s) 220, i.e. for storage and/or for receiving video. In some cases, video streams associated with a particular account may be received by the same one or more worker nodes 220 regardless of time of receipt, whereas in other cases the one or more worker nodes 220 which receive (or received) the associated video streams may vary with date/time of receipt. Similarly, in some cases, video streams associated with a particular account may be stored by the same one or more worker nodes 220 regardless of time of storage, whereas in other cases the one or more worker nodes 220 which store the associated video streams may vary with date/time of storage. Therefore once the account of the request is identified by manager node 210, the request can be forwarded to the one or more worker nodes 220 which has handled the requested video streams associated with the account (optionally for the given time/date).

As another example in order to ensure secure managed accounts, in one embodiment, one or more manager nodes 210 may have access to a correspondence between video sources 110, accounts and users. Therefore in this embodiment when a request for video is received by manager node 210 from a user, manager node 210 verifies that the user is authorized for the account and/or identifies video sources 110 associated with the account of the user from which video can be provided to the user.

As another example, parameters associated with CCSS 130 and/or with accounts managed by CCSS 130 may be accessible to one or more manager nodes 210, in order to ensure that CCSS 130 and/or the accounts function appropriately. Depending on the embodiment, certain parameters may be set by the operator, by the user and/or by either. For example in one embodiment, on the operator level, the operator can set one or more of the following parameters, inter-alia: the total number of slots per server and the number of users per slot; the storage size of account of each user; video sources associated with the account; retrieval and backup options; security and encryption options of recorded data; secure access protocols; compression method of the data; management tools of the data via for example an end user friendly graphical user interface GUI; the setup of broadcast protocol of the data, video/recording quality and advanced video options such as frame rate and captured video quality; presence or absence of different processing algorithms such as for example license plate recognition, motion detection, face recognition, etc; cyclical viewing rotation among video sources; video parameters; billing plan per account; and connectivity parameters. Examples of license plate algorithms can be found inter-alia at http://visl.technion.ac.il/projects/2003w24/, or in a paper titled “Car License Plate Recognition with Neural Networks and Fuzzy Logic” by J. A. G Nijhuis et al, details of which are incorporated by reference. A commercially available product that can be used for a license plate algorithm is NC6001 from NeuriCam headquartered in Italy, details of which can be found at http://www.neuricam.com/main/product.asp?4M=NC6001. Examples of face recognition algorithms inter-alia are listed at http://www.face-rec.org/algorithms/#Video, details of which are incorporated by reference. Examples of motion detection algorithms can be found inter-alia at http://www.codeproject.com/cs/media/Motion_Detection.asp, details of which are incorporated by reference. A commercially available product that can be used for a motion detection algorithm is Onboard from ObjectVideo, headquartered in Reston, Va., details of which can be found at http://www.objectvideo.com/products/onboard/index.asp

On the user level the range and scope of user authorizations and/or definition of parameters are determined in some embodiments by the system manager on the operator level. For example, for one account the associated user may be authorized only to view video whereas in another account the associated user may be authorized both to view video and change one or more parameters. If a user of an account includes a plurality of individuals, the authorization level may vary among the individuals. In one of these embodiments, one or more of the following parameters in one embodiment are potentially available inter-alia for user definition: destination devices; storage size of the account and account characteristics; transmission control; video quality; bandwidth control; video source parameters and video controls; backup and retrieval options; advanced video options (conditioned upon quality and type of camera capabilities); enabling/disabling of video sources and setting of resolution, audio and bandwidth, network configuration; and smart recording setups, including setup of recording (time of motion parameters), backup, retrieval and archiving. In one embodiment, the user may manage his account remotely from the video source(s) associated with the account.

In other embodiments, parameters described above as being at the operator level may instead or in addition be at the user level; and parameters described above as being at the user level may instead or in addition be at the operator level.

In some embodiments, some or all parameters that are initially set may not be later changed while in other embodiments some or all parameters may be adjusted after the initial set up. In some of these other embodiments there may be a limit on the number of times or the frequency of adjustment, while in other of these embodiments there may not be any limit.

In one embodiment, the correspondence between accounts and other factors, the user associated with each account and the level of authorizations for the user, parameters associated with each account, and/or tasks assigned to each worker node 220 are stored in a database accessible to manager node(s) 210 (and optionally to worker node(s) 220). (In an embodiment where one or more of these are available to worker node(s) 210, responsibilities described above for manager node(s) 210 may be shared with worker node(s) 220). The database can be located for example on any server(s) in CCSS 130 or on a storage area network SAN (for example commercially available from EMC Corporation based in Hopkinton, Mass.).

In some embodiments, storage of video is divided among worker node(s) 220. In one embodiment, the storage is redundant (i.e. at least two stored copies) so that there is a back up if less than all copies of a stored video are problematic.

In some embodiments, worker node(s) 220 perform any required or desired video processing. Examples of video processing include inter-alia: enhancement of video capabilities, such as supporting digital zoom for a camera without this feature; adaptation of the video to suit destination device 140, for example changing the codec, frames per second FPS, bit rate, bandwidth, screen resolution etc; running algorithms on the video such as for example license plate recognition, motion detection, face detection, etc; and merging and/or dividing video streams, for example in order to add commercials (generic or customized to the account). In some of these embodiments, one or more worker node(s) 220 may be dedicated to certain types of video processing. In other of these embodiments, all worker node(s) 220 may perform all video processing required or desired for particular video streams. For example, in one of these other embodiments, the same worker node 220 which handles the request for video from destination device 140 may also perform any required/desirable processing prior to transferring the video to requesting destination device 140. In some embodiments, the processing in worker nodes 220 (whether or not those worker nodes 220 are dedicated) is in some cases aided by dedicated hardware. For example one or more digital signal processors DSP may be used. Examples of DSPs which may be used are commercially available from Texas Instruments Incorporated, headquartered in Dallas, Tex. In some embodiments, the processing in worker nodes 220 (whether or not those worker nodes 220 are dedicated) is in some cases aided by software, for example to apply algorithms.

Below are discussed methods according to some embodiments of the invention for CCSS 130 receiving video from video source 110 and transmitting video to destination device 140. In these methods it is assumed that a user has already established an account with CCSS 130. Therefore, it will be briefly first discussed some ways a user may set up an account (i.e. register) with CCSS 130.

In one embodiment, assuming that a video source 110 is configured to follow the uniform protocol discussed above, a user may be prompted to establish an account as soon as a video source 110 unknown to CCSS 130 attempts to register with CCSS 130. In another embodiment, a user may set up an account by communicating with CCSS 130 or a representative of the operator, for example using WAP, using a web browser, by a phone call to a call center run by the operator, or by any other appropriate communication process. In another embodiment, an account for the user may be set up as part of a bundle of services offered by the operator to the user. In some embodiments, the user may define user level parameters when setting up an account and/or at a later date. In some embodiments the user may request that parameters associated with the account be set to certain definitions when setting up an account and/or at a later date. For example, if during set up then the user may provide the definitions of the user-level parameters or the requested operator-level parameters (subject to operator approval) along with the required information on the user. For example, if at a later date, the user may for example provide the definitions by communicating with CCSS 130 or a representative of the operator, for example using WAP, using a web browser, by a phone call to a call center run by the operator, or by any other appropriate communication process.

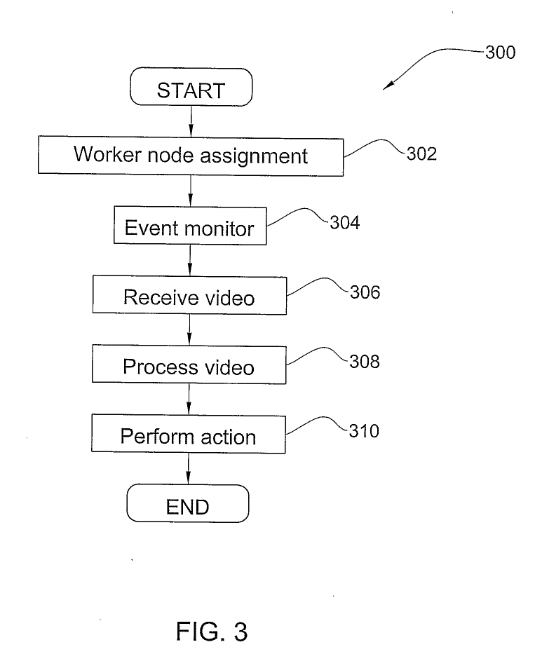

FIG. 3 is a flowchart of a method 300 for CCSS 130 receiving video from a video source associated with an account, according to an embodiment of the present invention. In other embodiments, method 300 may include additional stages, fewer stages, or stages in a different order than those shown in FIG. 3. For simplicity of description, each stage of method 300 refers to a single worker node 220 and/or manager node 210, however in other embodiments more than one worker node 220 and/or manager node 210 may perform any stage of method 300, mutatis mutandis.

In stage 302, management node 210 assigns a particular worker node 220 to monitor a specific video source 110 associated with a particular account. In stage 304, the assigned worker node 220 monitors video source 110 for the occurrence of one or more predefined events. At this stage it is assumed that video source 110 is connected to worker node 220 already. Depending on the embodiment, the assigned worker node 220 can wait for video source 110 to notify the assigned worker node 220 of the occurrence of one or more predefined events or the assigned worker node 220 can periodically poll video source 110 to see if an event has occurred. Predefined events are events which cause the assigned worker node 220 to request receipt of a video stream or which cause video source 110 to transmit a video stream to the assigned worker node (either for the first time or after a time interval of video not being sent). Depending on the embodiment, predefined events may be customized based on the associated account and/or may be universal to all accounts. For example, in one embodiment video is transmitted continuously, and in this case one of the predefined events may be the initial connection of video source 110 to CCSS 130 via network 120 as discussed above, or in the case of failure of video source 110, for example power failure, the event may be upon connection once the failure has been fixed. In one embodiment, in the case of a particular video source 110 that transmits the video over UDP, if no video packet is received for a predetermined period of time, CCSS 130 will detect a non-transmittal interval. In one embodiment, one of the predefined events can be time-related, for example the video may be transmitted during certain hours of the day, during certain days of the week, during certain dates of the year, after every predefined number of minutes has passed, etc. In this embodiment, the times of transmission may be customized to the account or universal. In one embodiment, one of the predefined events may not be time related, for example video may be transmitted after motion is detected by video source 110, video may be transmitted upon user request that video begin to be transmitted, video may be transmitted after user request to receive video from video source 110, etc. The invention is not bound by the number and/or type of events associated with an account.

In stage 306 video begins to be received by the assigned worker node 220. Depending on the embodiment the video can be transmitted on the pre-established connection or a new connection may be established for the video transmittal by worker node 220.

In an alternative embodiment to stages 302 through 306 described above, video source 110 connects to CCSS 130 when an event occurs and transmits the video, for example using the VCNCP protocol. For example video source 110 may have the IP address of a particular worker node 220 and video source 110 may transmit the video to the IP address of that particular node 220. Alternatively, video source 110 may begin sending video to a general IP address of CCSS 130 and then an available worker node 220 which captures the received video provides an IP address thereof to video source 110 so that the rest of the video is sent to the same worker node 220. Particular (receiving) worker node 220 may then use a parameter such as the component identification (as defined by the VCNCP protocol) of video source 110 in order to look up the corresponding account in the database, or receiving worker node 220 may provide the parameter to manager node 110 for lookup of the associated account. Alternatively, video source 110 may transmit the account number in association with the transmitted video.

In stage 308, processing of the video may optionally occur. For example, certain accounts may require application of one or more algorithms to the video stream, such as license plate recognition, motion detection, face detection, etc. As another example, certain accounts may require pushing the received video to one or more destination devices 140 associated with the account and in this case the processing may include one or more of the following inter-alia: preparing the video for transmission for example by adapting the video to suit destination device(s) 140, applying algorithms, cyclical viewing rotation among video sources, compensating for video source 110 deficiencies (for example adding a zoom), adding commercials (generic or customized to the account), etc. As discussed above the processing may occur at the same worker node 220 which received the video or at another dedicated worker node 220.

In one embodiment, the algorithms allow extraction of information from the video without viewing. For example, license plate recognition can include for example extracting all license plate numbers on video and/or determining if there are unfamiliar license plates. Motion detection can allow for example detection of whenever someone crossing in front of the video source 110, the count of the number of people crossing front of video source 110, and/or the detection of someone falling in the camera range of video source 110. Face recognition can include determining if there are unfamiliar faces. The type of information which can be extracted and the algorithms which can be applied are not limited by the invention.

In some embodiments, adapting (converting) the video to suit destination device(s) 140 may include for example transcoding and formatting of video data. In one embodiment, for each possible pair of video source 110 type- and destination device 140 type, the configuration data is stored in a database, for example located on any server(s) in CCSS 130 or on a storage area network SAN (for example an EMC). The communication and data protocols which allow the necessary conversions may have been automatically or manually determined at the user registration, at registration(s) of the video source 110/destination device 140 or at any other point in time. Therefore as long as the video source 110 and destination device 140 are known, any necessary conversions can be applied. For example in one embodiment, there may be listed in a database any conversions necessary for each possible pair of video source and destination device.

For example conversions of the video can include one or more of the following inter-alia: changing the codec, frames per second, bit rate, screen resolution, bandwidth, etc to meet the specifications of destination device 140.

It should be noted that for some destination devices 140, conversions may not be required. For example in some cases TVs have the same characteristics, and in these cases no transcoding is required.

In some embodiments, based on the results of processing, further processing may be required. For example, assuming the applied algorithms result in the desirability of pushing video to the user, in one of these embodiments further processing to prepare the video for transmission to the user may be performed.

In stage 310, one or more actions are performed relating to the video stream. Which action(s) are performed depend on the account. In some cases the account may define conditional action(s) whose performance or non-performance is dependent on the results of the processing of stage 308. The action(s) can be any suitable action(s). For example, the action(s) can include discarding all video, video which does not conform to certain account parameters and/or video which under certain conditions does not conform to predefined criteria (for example whose processing results do not conform to predefined criteria). Continuing with the example, in one embodiment, all video taken during certain hours of the day, during certain days of the week, during certain dates of the year, at not every predefined number of minutes (for example four out of five minutes of video is discarded) is discarded as new video comes in. Still continuing with the example in one embodiment all video in which motion is not detected by the applied algorithm is discarded. Still continuing with the example, in one embodiment all video which when license plate recognition or face recognition is applied, does not show an unknown license plate/face, is discarded. As another example, the action(s) can include storing all video, video which conforms to certain account parameters, and/or video which under certain conditions conforms to predefined criteria (for example whose processing results conform to predefined criteria). Continuing with the example, in one embodiment, all video taken during certain hours of the day is stored, during certain days of the week, during certain dates of the year, at every predefined number of minutes (for example every fifth minute of video is stored), for example for a predefined period of time. Still continuing with the example in one embodiment all video in which motion is detected by the applied algorithm is stored. Still continuing with the example, in one embodiment all video which when license plate recognition/face recognition is applied shows an unknown license plate/face is stored. In one embodiment storage of the video is at or in proximity to worker node 220 performing the processing. In one embodiment the video is stored redundantly at more than one worker node 220 (regardless of whether the processing occurred at more than one worker node 220 or not). In one embodiment, the storage location corresponding to the given time period of the video is provided to one or more manager nodes 210, and manager node(s) 210 establishes the correspondence between storage location and account so that the stored video can later be accessed by the user of the associated account.

As another example, the action(s) can include notification to the user of the account regarding all video, video which conforms to certain account parameters and/or video which under certain conditions conforms to predefined criteria (for example whose processing results conform to predefined criteria). Continuing with the example, in one embodiment, the user may be notified that an event has occurred and video is being or has been received. Still continuing with the example, in one embodiment, the user may be notified whenever the processing of the received video requires user attention, for example the processing has resulted in detected motion or an unknown license plate/face. Still continuing with the example, in one embodiment, the user may be notified that there is new stored video. The notification can be through any known means including inter-alia email, short message service SMS, multi-media messaging service MMS, phone call, page etc. In one embodiment, the notification may include some or all of the video which is the subject of the notification. For example part or all of the relevant video may be sent as an attachment to an email.

As another example, the action(s) can include pushing the video or the video after processing (processed version) to the user, at one or more predetermined destination devices 140 (registered) associated with the account. Continuing with the example all video/processed video, video/processed video which conforms to certain account parameters and/or video/processed video which under certain conditions conforms to predefined criteria (for example whose processing results conform to predefined criteria) may be pushed to the user.

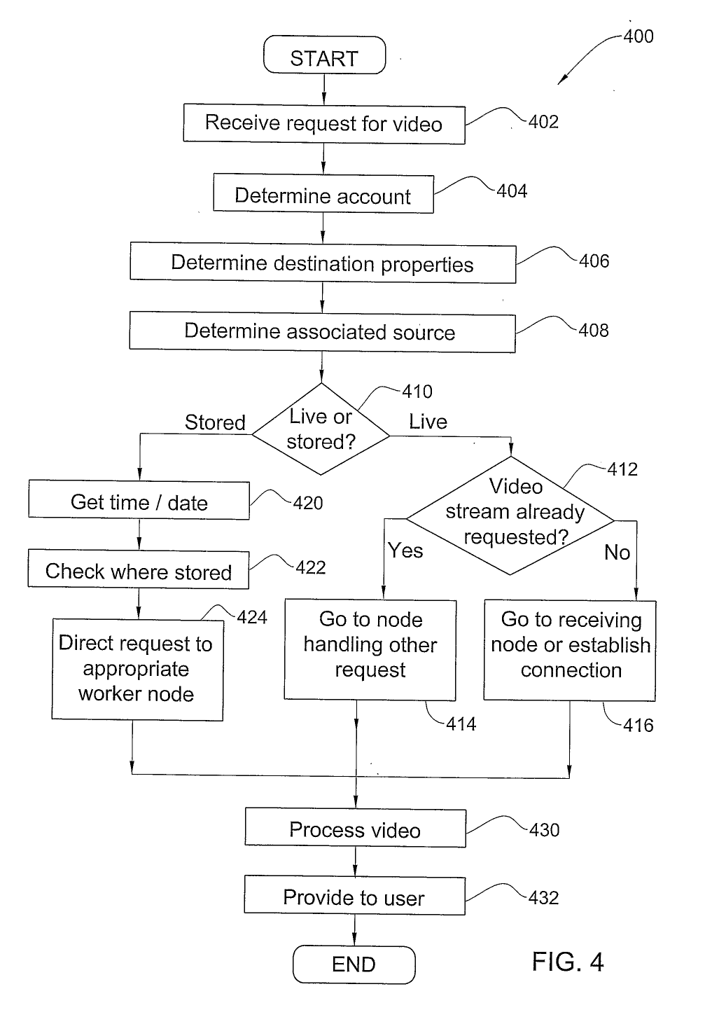

FIG. 4 is a flowchart of a method 400 for accessing video associated with an account, according to an embodiment of the present invention. For the sake of simplicity, it is assumed that the request relates to video from one video source 110, but in embodiments where the request relates to video from more than one video source 110, similar methods and systems to those described here can be used, mutatis mutandis. In other embodiments, method 400 may include additional stages, fewer stages, or stages in a different order than those shown in FIG. 4. For simplicity of description, each stage of method 400 refers to a single worker node 220 and/or manager node 210, however in other embodiments more than one worker node 220 and/or manager node 210 may perform any stage of method 400, mutatis mutandis.

In stage 402, CCSS 130, for example, manager node 210 receives a request for video associated with a particular account. For example, the user may request the video using client destination device 140. In another embodiment, the user may request the video using another device and specify client destination device 140 on which the video will be viewed. Communication between the user and CCSS 130 can be for example using a web browser, WAP, a customized application, and/or a dedicated module. Depending on the embodiment, the user may request the video proactively, i.e. without any notification from system 130 and/or may request the video in reaction to a notification from CCSS 130 (for example after stage 310 discussed above).

In stage 404, the account is determined. Depending on the embodiment, manager node 210 can determine the account associated with the user by any conventional means, for example by the IP address of the user, by the user name and/or password provided by the user, by the account number provided by the user, etc.

In one embodiment, assuming the user is using a phone device 140 to request the video, CCSS 130 may take advantage of the caller line identification CLI structure used in calls. For example, the CLI structure may include the handset device model and the phone number. In some cases, based on the phone number, manager node 210 which receives the request may retrieve the associated account.

In another embodiment, assuming the user is using a destination device 140 with a customized application, the application may communicate the account number to CCSS 130.

In stage 406, the destination properties for destination device 140 are determined. For example assuming the CLI structure, CCSS 130 may maintain a catalog of available handset device models and suitable video characteristics, and for example the manager node 210 which receives the request (or for example the worker node 220 which later performs the adaptation of the video to suit destination device 140) may look up the handset device model and thereby determine the video properties which suit destination device 140.

In another embodiment, assuming the user is using a destination device 140 with a customized application, the application may communicate relevant destination device properties to CCSS 130.

In another embodiment, the destination properties had been previously stored at CCSS 130 in association with the account during registration and therefore some or all of the properties may be retrieved.

In stage 408, manager node 210 which received the request determines one or more sources 110 associated with the account and the source 110 whose video is requested by the user. For example, in one embodiment manager node 210 may determine the sources 110 associated with the account, for example through a look up table, provide the user with those sources 110, and the user may then request video from one of those sources 110. In another embodiment, the user may proactively specify from which source 110 associated with the account video is requested. In one embodiment, the user may select cyclical rotation whereby video is alternately provided from two or more sources 110 associated with the account.

In stage 410, manager node 210 determines if the user requests a live feed or a recorded (stored) video (stage 306), based on received input from the user. If the request is for a live feed, then method 300 proceeds to stage 412. In some embodiments, destination device 140 may be connected directly to source 110, bypassing worker node 220 whereas in other embodiments the live feed may go through worker node 220. In the description here it is assumed the connection is through a worker node 220. For example, in one embodiment if the live feed from a particular video source 110 is currently being provided to another destination device 140 by a particular worker node 220 (stage 412), one or more of the same worker node 220 may be delegated the task of providing the live feed to the particular video source 110 (stage 414). Continuing with this example, if the live feed from a particular video source 110 is not being currently provided to another destination device 140, the task of providing the live feed may be allocated to a particular worker node 220 which is receiving the live feed from the particular video source 110 (stage 416). Still continuing with the example if a live feed is not currently being received from the particular video source 110, in alternative stage 416 the request may be forwarded to any worker node 220 which will be charged with the task of establishing a connection with the particular video source 110 and controlling the particular video source 110 (for example asking the particular video source 110 to begin broadcasting, etc.).

If the request is instead for stored video in stage 410, then method 400 proceeds with stage 420 where manager node 210 receives the requested time/date of the stored video from the user. In stage 422, manager node 210 looks up where the requested video is stored, for example through a look up table and in stage 424 manager node 210 delegates the request to the particular worker node where the video is stored, or to the closest available worker node to the storage location.

In stage 430 processing of the video optionally occurs, and in stage 432 the video (as received) or a processed version of the video is provided to destination device 140 of the user. The processing may be based on account parameters, user inputs, and/or characteristics of destination device 140. Processing based on account parameters and characteristics of destination device 140 has been discussed above—see for example the discussion of stage 308. Processing based on user inputs refers to processing requested by the user during method 400, for example processing which is not systematically applied to video streams associated with the account, but which the user wants applied to the currently requested video. Depending on the embodiment, the user may select any type of processing, for example processing discussed above, be applied to the currently requested video.

In some embodiments, stage 408 through 432 may be repeated during a user session, as a user requests video from other sources 110 associated with the account during the same session.

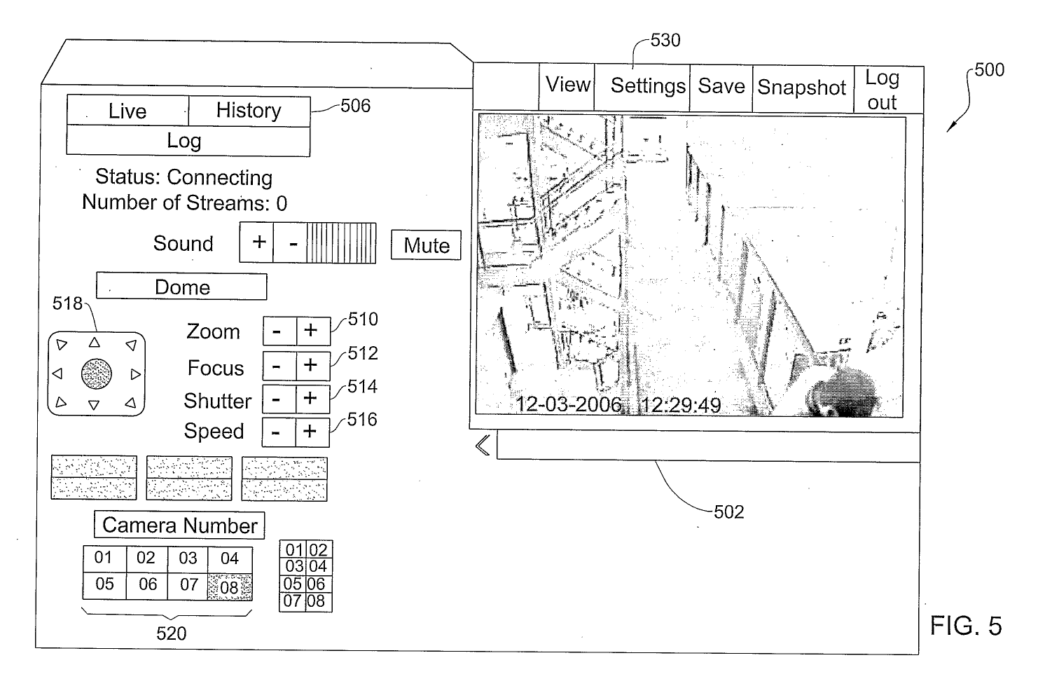

Refer to FIG. 5 which shows an example of a GUI 500 on a destination device 140. The invention is not bound by the format or content of GUI 500. In screen 502, the video stream provided in stage 432 is displayed (in this case the video is live). By clicking on “live” or “history” in section 506 (stage 410) the user may make the desired selection. By clicking on zoom 510, focus 512, shutter 514 or speed 516 and adjusting dome 518 the user can perform the corresponding processing on the video (section 430). By clicking on one of associated sources 110 listed in section 520, the user can select the particular source 110 of the video (stage 408) and/or switch the source of the displayed video (repetitions of stage 408). By clicking on settings 530, the user may bring up other GUIs which allow the user to define and/or view user level parameters. As mentioned above, depending on the embodiment the user may or may not be allowed to define again some or all user level parameters after the initial definition. For example in one embodiment, there are GUIs which allow a user to define and/or view inter-alia one or more of the following: general settings (time, interface language, default video source, enable/disable local video play, auto stop video, auto stop video timeout, swap view enabled local/TV out, swap vide timeout, swap view video source, etc.), users (add new user [password, authorization level, expiration, etc.], change user [password, authorization level, password, etc.], etc), video settings (web video control [channel, enable FPS, Group of Pictures GOP, quality range, resolution, bandwidth, etc.], LAN video control [channel, enable FPS, quality range, resolution, bandwidth, etc.], PDA video control [channel, enable FPS, GOP, quality range, resolution, bandwidth, etc.], channel control, color control [channel, brightness, hue, saturation, contrast, etc.], etc), add cellular stream (image duration, cycle duration, FPS, bit rate, GOP, quality range, codec, packet size, IP address, port, camera [number, in cycle, image, etc], etc), list cellular stream (camera, enabled/disabled, etc), audio settings (camera, audio on/off, etc), scheduler (camera, record video, record on video motion detection, etc), network settings, dome settings, maintenance, camera status (video source, status, message, etc), and other settings.

As mentioned above, in one embodiment the user may make the request for the video, view settings, and/or define settings using a device other than destination device 130.

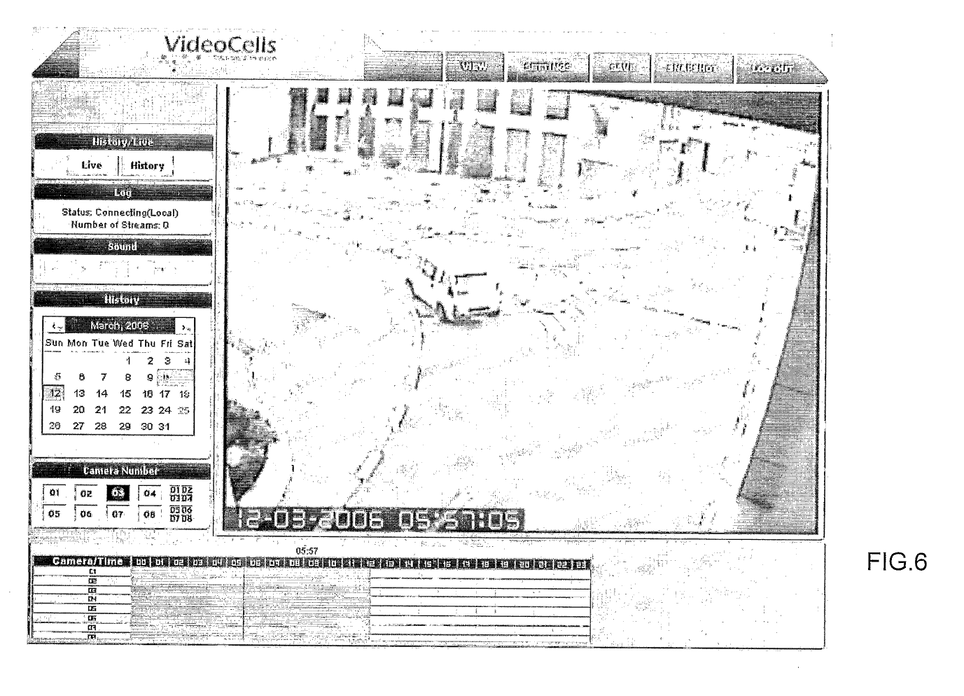

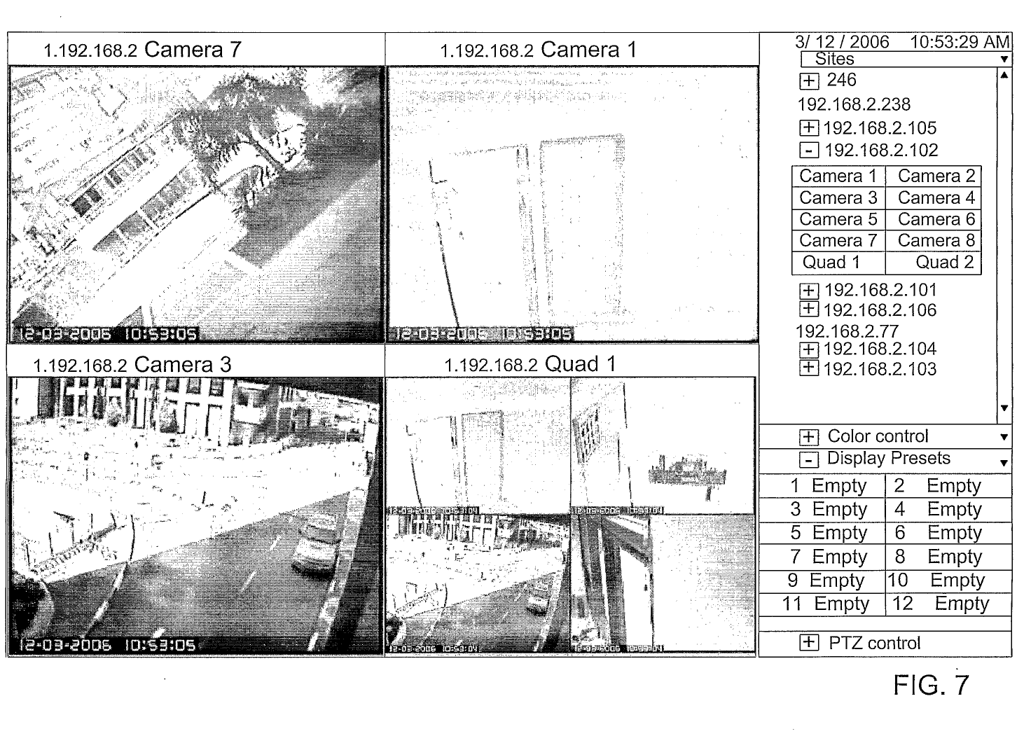

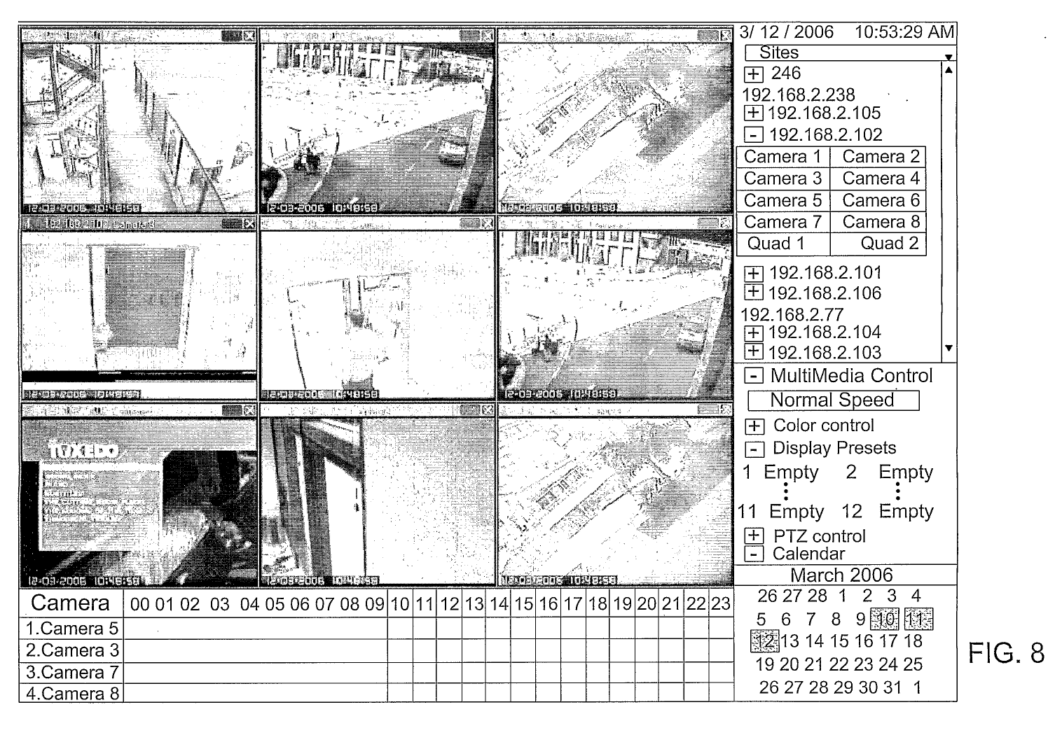

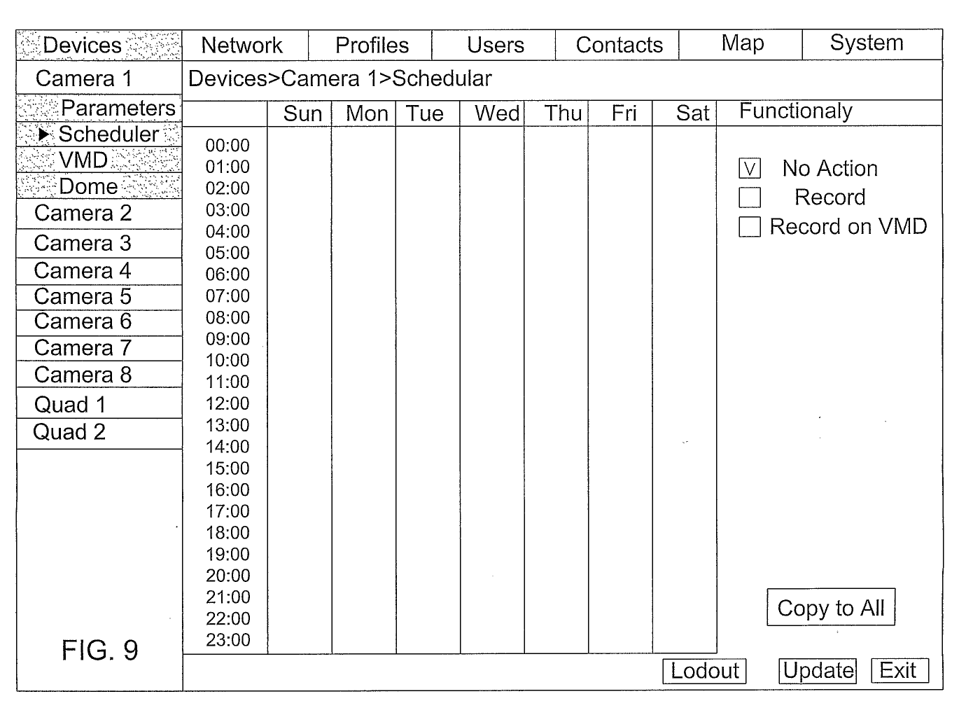

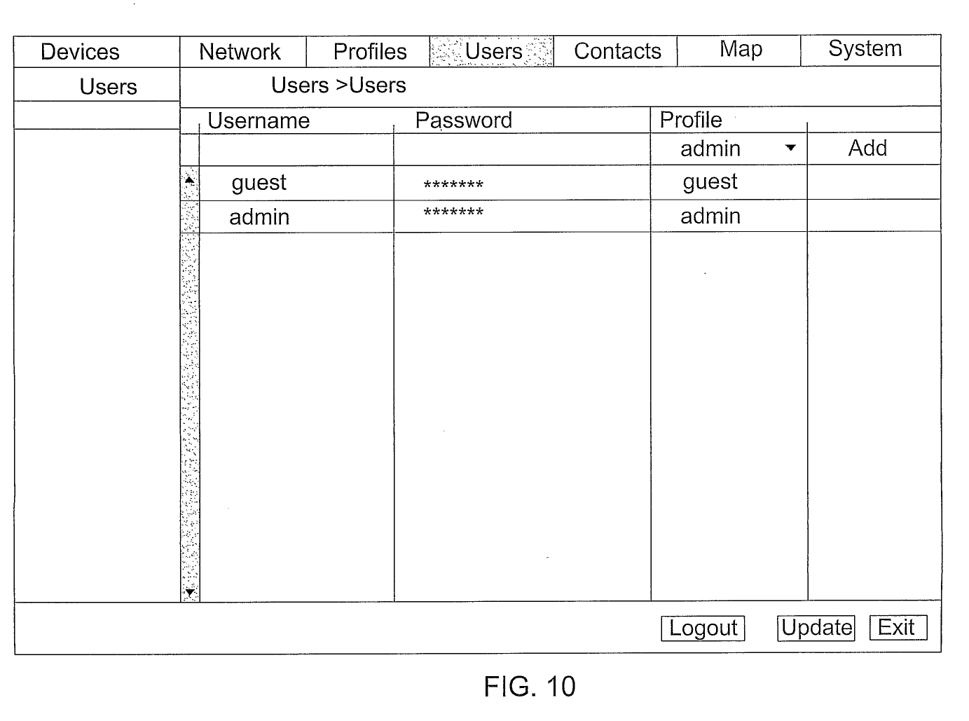

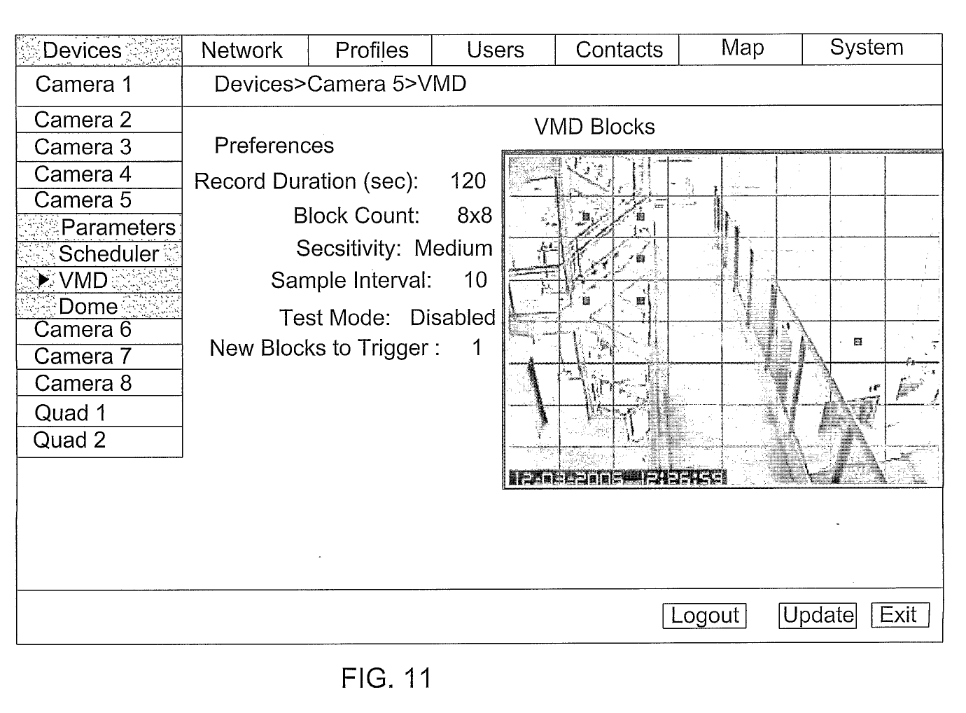

To further the reader understanding, other examples of GUIs are illustrated in FIGS. 6 through 11. The invention is not bound by the format or content the GUIs presented in FIGS. 6 through 11. FIG. 6 illustrates a web based GUI with a history stream playing and with the timeline displayed. FIG. 7 illustrates a web based GUI with four live streams playing simultaneously. FIG. 8 illustrates a web based GUI with nine history streams playing simultaneously and with the timeline displayed. FIG. 9 illustrate a web based GUI with a video recording scheduling screen. FIG. 10 illustrates a web based GUI for a users configuration screen. FIG. 11 illustrates a web based GUI for a video motion detection VMD setup screen with the ability to select individual zones on which the VMD will run. An analysis of a zone of the video or the whole video may be run so that if motion is detected an action is fired. (Note that as mentioned above motion detection may instead or also be performed by video source 110, in which case the detected motion could be considered an event as described above).

Centralizing all necessary computing and management tasks at CCSS 130 may in some embodiments allow a major downsizing of the demanded capabilities on both source 110 and destination 140 ends. For example, the source video 110 may then be an extremely simple and “stupid” IP camera which is directly connected to a wired or wireless internet socket. Similarly, the destination client need not dedicate extensive computation and storage resources for the task at hand. The proposed configuration therefore allows extreme connectivity flexibility, literally allowing any type of destination client 130 to receive real-time or prerecorded (stored) video data from any type of source 110.

More details on one embodiment of the uniform protocol VCNCP are now provided.

### Introduction

The following paragraphs describes a communication protocol (VCNCP) between a network component (“C”) which can provide a system with any combination of video, audio and/or data streams and the system (“S”). Such components can include inter-alia: network camera (IP Camera) a software application, a remote microphone device, etc. The purpose of this protocol is to provide smooth integration of peripheral data provided by devices to a system. The protocol emphasizes reliability and versatility. The protocol in this embodiment is conducted under TCP connection. Each session begins with a login using a username and password and protocol negotiation (part of the login stage). The session is kept open indefinitely. The protocol is message oriented, meaning every message is preceded by a message type which describes the data that is about to follow. The component connects to the system in a well known port and well known address. The abbreviation “uint” is used below for “unsigned integer”.

In one embodiment of the protocol, the “system” or “server” described with reference to the protocol refers to CCSS 130 and the network components described with reference to the protocol refer to video sources 110.

### Messages Definition

Each message in the protocol is preceded by a header which contains:
uint16—message type.
uint32—message size.

| | |
|---|---|
| Uint16 | Message type |
| Uint32 | Message size |

Strings are NULL terminated Unicode strings, encoded in UTF8.

### 0000—Registration Request

Request the system for registration of the component.

| | | |
|---|---|---|
| String | Component Name | Component Name |
| String | Component Manufacturer | Component Manufacturer |
| String | Component Description | |
| 2 x uint64 | Component ID | Unique ID representing this |
| | | component - like a MAC |
| | | address for the component. |

### 0001—Registration Reply

After registration, the system replies the component with this message to signify success or failure.

| | | |
|---|---|---|
| Uint8 | Success code | See list below. |

In case of failure the following fields are sent also

| | | |
|---|---|---|
| String | Extended description | Contains extended |
| | | description for the failure. |

### Success Codes

| | |
|---|---|
| 0 | Success. |
| 1 | Failure - Already registered. |
| 2 | Failure - Registration not allowed. |

### 0002—Login Request

Request to log-in to the server.

| | | |
|---|---|---|
| String | User name | User name to log-in to the |
| | | system with. |
| 2 x uint64 | Component ID | ID of the requesting |
| | | component |
| Uint8 | Protocol version | The requested protocol |
| | | version |
| | | See list below. |

### Protocol Versions

| | |
|---|---|
| 1 | Version 1 of the protocol - simple profile of this protocol |
| | contains only control messages. |

### 0003—Login Challenge

Message sent by the server to authenticate the component.

| | | |
|---|---|---|
| String | Challenge string | Challenge string that needs |
| | | to be digested with the |
| | | password. |
| Uint32 | Challenge ID | ID for this challenge |

### 0004—Login Challenge Response

Message sent by the component to authenticate itself with its secret with the server.

| | | |
|---|---|---|
| 5 x uint32 | SHA1 challenge response | SHA1 challenge hash, see |
| | | below. |
| Uint32 | Challenge ID | ID for the challenge |

The challenge string is interleaved with the password and hashed using SHA1 algorithm.

### 0005—Login Reply

Sent by the server, it tells the component if the authentication was successful or not and also if the requested protocol version is supported.

| | | |
|---|---|---|
| Uint8 | Status code. | See below. |
| (optional) String | Extended description | Contains extended |
| | | description for the failure. |

### Status Codes

| | |
|---|---|
| 0 | Success. |
| 1 | Failure - Authentication failed. |
| 2 | Failure - Protocol unsupported. |

### 0006—Mode Request

Sent by the component to notify the server about the mode the component is about to enter.

| | | |
|---|---|---|
| Uint8 | Mode | See below. |

### Modes

| | |
|---|---|
| 0 | Enter registration stage. |
| 1 | Enter ready stage. |

### 0007—Ping Message

Sent by the server and then by the component to reply to the message

| | | |
|---|---|---|
| Uint16 | Ping ID | Random number generated by the |
| | | server, the component should reply |
| | | with the same random number. |

### 0008—Query Capabilities

Sent by the server to ask the component what options it supports.

| | | |
|---|---|---|
| Uint8 | Query type | Type of option to query |
| | | The rest of the fields depend |
| | | on the query type. |

Possible query types and additional fields.

| 0 | Get streaming capabilities. | | |
|---|---|---|---|
| 1 | Get supported options. | | |
| | Uint8 | Stream index | Stream to query options |
| | | | for, 0 means general |
| | | | component options. 1 is |
| | | | the first stream, 2 is the |
| | | | second stream and so on. |

### 0009—Query Reply

The reply is sent by the component, it depends on the query type.

| | | |
|---|---|---|
| Uint8 | Query reply type | Same type as the query |
| | | message. |

Possible query reply types and the rest of the fields (which depend on the query type).

| 0 | Get streaming capabilities. | | |
|---|---|---|---|
| | Uint8 | Supported transmission | What protocols does this |
| | | protocols. | component support to |
| | | | send the streams. See |
| | | | below. |
| | Uint8 | Streams count | Number of streams this |
| | | | component produces. |
| | These fields repeat for each stream (according to the streams count). | | |
| | Uint8 | Major stream type. | Major type of this stream. |
| | | | See below |
| | Uint8 | Minor stream type. | Minor type of this stream. |
| | Uint8 | Stream properties count | Number of stream |
| | | | properties that follow |
| | Stream property. | | |
| | String | Property name | Depends on the stream |
| | | | type. |
| | String | Property value | Depends on the property |
| | | | name. |
| 1 | Get supported options. | | |
| | Uint8 | Stream index | 0 is general component |
| | | | options, 1 is first stream 2 |
| | | | is for second stream and |
| | | | so on. |
| | Uint8 | General options count. | Number of options |
| | | | structures that follow |
| | Each option is composed of these fields. | | |
| | String | Option name | Name of the option |
| | String | Option description | Description for the option |

### Transmission Protocols

| | |
|---|---|
| 0 | RTP |

### Major/Minor Stream Types and Possible Properties.

| | |
|---|---|
| 0 | Video |

| | 0 | H263 | |
|---|---|---|---|
| | | Width | Video width. |
| | | Height | Video height |
| | | FPS | Video FPS |
| | | BPS | Bit rate - Bits per second |
| | 1 | MPEG4 | |
| | | Width | Video width. |
| | | Height | Video height |
| | | FPS | Video FPS |
| | | BPS | Bit rate - Bits per second |
| 1 | Audio | | |
| | 0 | MP3 | |
| | | Sample Rate | Audio sample rate. |
| | | BPS | Bit rate - Bits per second |
| | 1 | AAC | |
| | | Sample Rate | Audio sample rate. |
| | | BPS | Bit rate - Bits per second |
| | 2 | AMR | |
| | | Sample Rate | Audio sample rate. |
| | | BPS | Bit rate - Bits per second |

### 000A—Change Configuration

Sent by the server to change the configuration of the component.

| | | |
|---|---|---|
| Uint8 | Stream index | 0 is general component |
| | | option, 1 is the first stream 2 |
| | | is the second stream and so |
| | | on. |
| String | Option name | The name of the option to |
| | | change. |
| String | New option value | New value for the option. |

### 000B—Change Streaming State

Sent by the server to change the streaming state of the component.

| | | |
|---|---|---|
| Uint8 | Stream index | Index of the stream to |
| | | change (begins from 0). |
| Uint8 | New state | See below for possible |
| | | states. |

### Possible States

| | |
|---|---|
| 0 | Play stream |
| 1 | Stop stream |

### Stages

Login Stage

The login stage is performed at the beginning of each session, and is responsible for authenticating the user and negotiating protocol version (for support of future protocol enhancements).
The authentication method is similar to CHAP used in PPP.

### Dialog:

C: Login request—contains username and component ID and requested protocol level.
S: Login reply—protocol supported or unsupported.
If unsupported, the component can re-request to login with a lower level protocol.
We send the challenge only if the reply was success.
   S: Login challenge—contains a challenge string.
   C: Login challenge response—contains challenge string and the user password hashed with SHA1.
   S: Login reply—contains login status.
The component is eligible to retry to login again.
The server is free to disconnect the component at any time if failed.
If successful, the component should send the requested mode.
   C: Mode request.
   Further communication with the server depends on the entered mode.

Registration Stage

Registration stage is done once for each component, in this stage the component registers itself with the system; it provides information regarding itself.
The registration process is conducted in a dialog manner.
The registration stage is optional; it can be made without interaction with the component.

### Dialog:

C: Registration request—contains information regarding the component.
S: Registration reply—return registration status—approved or not and why not.

Ready Stage

In this stage the component awaits for instructions from the server, it can receive any of the following messages:
Query capabilities.
Change streaming state.
Change configuration.
Ping message.

While the invention has been shown and described with respect to particular embodiments, it is not thus limited. Numerous modifications, changes and improvements within the scope of the invention will now occur to the reader.

1. A system for providing users with video services over a communication network comprising:
a clustered centralized streaming system configured to receive over a communication network videos from video sources associated with a plurality of accounts and configured to transmit over a communication network said received videos or processed versions thereof to corresponding users of said plurality of accounts.

2. The system of claim 1, wherein said clustered centralized streaming system includes a plurality of servers, said plurality of servers including servers configured to receive requests for videos from users and configured to delegate said requests to other servers included in said plurality, and wherein said clustered centralized steaming system is configured to provide load balancing so that requests are delegated efficiently among said other servers.

3. The system of claim 1, wherein said clustered centralized streaming system is configured to process said received videos in accordance with said accounts.

4. The system of claim 1, further comprising: a plurality of destination devices, wherein said clustered centralized streaming system is also configured to adapt, if necessary, said videos to characteristics of said destination devices.

5. The system of claim 1, wherein said clustered centralized streaming system is configured to process a received video by at least one process selected from a group comprising, apply at least one algorithm to extract information from said video, enhance video capabilities, compensate for video source deficiencies, add digital zoom, adapt video to suit a destination device, change the codec, change the frames per second FPS, change the bit rate, change the bandwidth, change the screen resolution; run an algorithm on said video, run a license plate recognition algorithm on said video, run a motion detection algorithm on said video, run a face recognition algorithm on said video, merge video streams, divide a video stream, add generic commercials to said video, add account customised commercials to said video (generic or customized to the account), provide cyclical viewing rotation among video sources, transcode said video, change the format of said video, change the focus, change the shutter, and change the speed.

6. The system of claim 1, wherein said clustered centralized streaming system includes a plurality of servers for storing videos received from said video sources and wherein said clustered centralized streaming system is configured to store a correspondence between said stored videos and corresponding accounts.

7. The system of claim 1, wherein said clustered centralized streaming system includes expandable and redundant storage of videos.

8. The system of claim 1, wherein said clustered centralized streaming system is configured to manage video associated with each account at least partially in accordance with parameters associated with said each account.

9. The system of claim 8, wherein said parameters include at least one selected from a group comprising: the storage size of account of each user; retrieval and backup options, security and encryption options of recorded data; secure access protocols compression method of the data; management tools of the data; the setup of broadcast protocol of the data, video/recording quality and advanced video options; presence or absence of different processing algorithms; cyclical viewing rotation among video sources; video parameters; billing plan per account; and connectivity parameters; destination devices; video sources; account characteristics; transmission control; video quality; bandwidth control; video source parameters; video controls; backup and retrieval options; advanced video options; enabling/disabling of video sources; setting of resolution, audio and bandwidth; network configuration; smart recording setups; setup of recording (time of motion parameters), backup, retrieval and archiving; general settings; users; user authorizations; video settings; cellular streams; audio settings; scheduler; network settings; dome settings; maintenance, and camera status.

10. The system of claim 1, further comprising: a plurality of video sources, wherein said clustered centralized streaming system also includes at least one adapter configured to communicate with said plurality of video sources.

11. The system of claim 10, wherein at least one of said plurality of video sources is configured to register with said clustered centralized streaming system using a uniform protocol and said at least one adapter includes an adapter configured to communicate with said at least one video source.

12. The system of claim 1, wherein said clustered centralized streaming system is configured to transmit live and stored videos.

13. A method of a clustered centralized streaming system providing users with video services over a communication network comprising:
upon occurrence of an event, receiving a video stream from a video source associated with an account via a communication network; and
performing an action relating to said video stream in accordance with said account.

14. The method of claim 13, further comprising: processing said video stream.

15. The method of claim 13, wherein comprising: assigning a server to monitor said video source for said event.

16. The method of claim 13, wherein said action includes at least one selected from a group comprising: discarding said video steam, saving said video stream saving any of said video stream conforming with predetermined account parameters, saving any of said video stream whose processing results conform with predetermined criteria, notifying a user associated with said account, notifying a user associated with said account regarding any of said video stream conforming with predetermined account parameters, notifying a user associated with said account regarding any of said video stream whose processing results conform with predetermined criteria, pushing said video stream or a processed version thereof to a user associated with said account, pushing any of said video stream or a processed version thereof conforming with predetermined account parameters to a user associated with said account and pushing any of said video stream or a processed version thereof whose processing results conform with predetermined criteria to a user associated with said account.

17. A method of a clustered centralized streaming system providing users with video services over a communication network comprising:
receiving from a user a request for video;
determining an account associated with said request;
determining a video source valid for said account and said request; and
providing video from said determined video source or a processed version thereof to said user.

18. The method of claim 17, further comprising:
receiving a request for live video from said video source;
determining if another request for live video from said video source is currently being handled by a server in said clustered centralized streaming system; and
if another request is currently being handled by a server in said clustered centralized streaming system, delegating said request to said server.

19. The method of claim 17, further comprising:
receiving a request for stored video from said video source;
determining at which server in said clustered centralized streaming system said video is stored; and
delegating said request to said server where said video is stored.

20. The method of claim 17, further comprising:
determining at least one property of a destination device to which said video or a processed version thereof is to be provided and if necessary adapting said video or a processed version thereof to suit said destination device.

21. A method of providing a clustered centralized streaming system with video, comprising:
upon occurrence of an event, a video source associated with an account transmitting a video stream to a clustered centralized system via a communication network,
whereby said clustered centralized streaming system performs an action relating to said video stream in accordance with said account.

22. A method of a user receiving video services over a communication network from a clustered centralized streaming system, comprising:
a user transmitting a request for video to a clustered centralized steaming system via a communication network, and
a user receiving from said clustered centralized streaming system video, originating from a video source associated with an account corresponding to said request, or a processed version thereof.

23. A protocol for communicating between a clustered centralized streaming system and a network component, comprising:
a network component sending a registration request, including a component identification and
said clustered centralized streaming system returning a registration reply inditing success or failure for said registration request.

24. The protocol of claim 23, further comprising:
if said registration reply indicates success, said component entering a ready mode, wherein during said ready mode said component may receive at least one message selected from a group comprising: Query capabilities, Change streaming state, Change configuration, and Ping message.

25. The protocol of claim 23, further comprising:
said network component sending a login request including said component identification to said system when transmitted is desired.

26. The protocol of claim 23, wherein said network component is a video source.
